(19) United States
(12) Patent Application Publication
(10) Pub. No.: US 2008/0113534 A1
(43) Pub. Date: May 15, 2008

(54) Hollow Bar Manufacturing Process

(75) Inventor: Peter A. Gray, Fig Tree (AU)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Peter Andrew Gray, Fig Tree (AU)

(21) Appl. No.: 12/014,903

(22) Filed: Jan. 16, 2008

Related U.S. Application Data
(63) Continuation of application No. 10/569,889, filed on Oct. 16, 2006.

(51) Int. Cl. H01R 25/00

(52) U.S. Cl. 439/115

(57) ABSTRACT

A process to form a substantially thick walled hollow bar by hot rolling an elongate member to form an internal hole, whereby the elongate member is formed around the internal hole and the outer edges of the elongate member are brought substantially into contact with each other or into close proximity to each other such that the outer edges form substantially longitudinal contact faces capable of being forced into very close or intimate contact with each other.

### CROSS-REFERENCE TO RELATED APPLICATION

This application is a continuation of U.S. application Ser. No. 10/569,889 Oct. 16, 2006, which claims priority from PCT/AU03/001114 filed Aug. 28, 2003, which is corresponding to Australian application no. 2003257237 filed Aug. 28.2003.

### FIELD OF THE INVENTION

The present invention relates to a method of forming a hollow bar. More particularly, the present invention relates to a method of forming a thick-walled hollow bar by rolling or forming or wrapping an elongate member such that it substantially contains a internal hole, and where the outside edges of the elongate member are substantially in contact with each other, but are not necessarily bonded to each other.

### BACKGROUND TO THE INVENTION

Hollow bars can be manufactured in a number of different ways and are used for different applications. In the case of steel hollow bars, they are currently made by one of two processes.

They are either made by using the pipe or tube manufacturing process, or by using the pierced billet manufacturing process.

Pipes or tubes are made by taking a long strip of cold steel and rolling it around into a circle and then welding the two contact edges together by using a process called Electric Resistance Welding or ERW. The advantage of this process is that it is a very common method used around the world for a wide range of different sized pipes or tubes. One major advantage of the ERW process used to manufacture pipes and tubes is that it forms an extremely strong welded joint, and typically the welded joint is at least as strong as the parent metal in the pipe or tube. This manufacturing process is therefore ideally suited to produce hollow bars, which have to resist high internal pressures from pumping fluids.

However, a disadvantage is that the wall thickness is always thin relative to the central hole size, and therefore it is difficult to obtain very high strength from small diameter tubes. For a tube say 30 mm in diameter that would be suitable for use as a bolt, the maximum wall thickness that can be achieved is typically less than 4 mm, or a ratio of about 8:1 or greater.

Tubes can be heat treated to obtain high strength, but then the elongation properties of the steel decrease dramatically and make them unsuitable for use as a self drilling rock bolt.

In addition, if the pipe or tube is used as a self drilling rock bolt, the large central hole consumes a large volume of resin which is expensive, and adds to the overall costs of the bolt.

Some tubes are used to make rock bolts (such as Swellex, split sets, & Hollow Groutable Bolts) but such bolts are generally low strength and/or are anchored with low cost cement grout rather than with resin.

Another disadvantage of tubes if they are used as rock bolts is that the surface profile of the tube is generally smooth and the load transfer characteristics are very poor. Tubes can be continuously threaded on their outside surface to increase the load transfer capacity, but this also adds to production costs. Tubes are made in Australia by OneSteel and by Palmer Tubemills.

An alternative method to manufacture hollow bars is the pierced billet manufacturing process.

This process can produce a thick walled hollow bar with a relatively small central hole and a thick wall thickness. This is achieved by firstly drilling a hole into a short billet of steel (typically 1.5 m long by 250 mm in diameter) and then inserting a special non-stick mandrel into that hole. The billet of steel is then heated up and subsequently hot rolled out to its final diameter and shape. The mandrel is then pulled out of the central hole leaving a thick walled hollow bar. The advantage of this process is that high strength bars can be made this way because the cross sectional area of steel is large. In addition, in the case of rock bolts or concrete reinforcing bars, a hot rolled profile or thread can be formed on the outside of the bar during rolling such that a high load transfer bar can be produced. Finally, the relatively small central hole does not consume much resin, and therefore the bar is ideally suited to be used as a groutable or self drilling rock bolt.

However, the major disadvantage with pierced billet bars is that they are very expensive and they are all imported into Australia. This very high cost simply makes them uneconomic to be in widespread use as rock bolts in the mining industry. Bolts made from pierced billet rods are therefore only used for specialist applications.

There are other processes to manufacture hollow bars including die drawing and centrifugally spun bars, but they are usually very expensive and are only used for specialist applications.

However, all existing hollow bars, whether they be pipes, tubes or very thick-walled pierced billet bars, have one thing in common and that is that they have a substantially uniform and high radial tensile strength. Existing hollow bars do not have a section of the bar, which is substantially weaker than the rest of the bar. In the case of pipes or tubes, the ERW contact joint is typically slightly stronger than the rest of the pipe, and in the case of pierced billet hollow bars, centrifugally spun bars and die drawn bars, the wall of the bar has a completely uniform radial tensile strength.

Nevertheless, this high and uniform radial tensile strength in the wall of existing hollow bars comes at a high price. Therefore, the high cost of existing hollow bars, or limitations with their design, makes them unsuitable for some applications. In particular, for applications for self drilling rock bolts or groutable rock bolts, pierced billet hollow bars are generally too expensive, and pipes and tubes have limitations in axial tensile strength.

The present invention is concerned about a new method to manufacture hollow bars, which has substantial advantages in both cost and speed of production compared to existing methods. Specifically, a thick-walled hollow bar can be produced in a hot rolling mill where the bar has at least one axial joint or contact face or contact faces along the outside of the hollow bar, which may be substantially weaker than the rest of the hollow bar. The radial tensile strength in the wall of the hollow bar therefore may not be uniform.

A thick-walled hollow bar can be formed by this new process by forming a substantially hollow shaped bar in a hot rolling mill by rolling an elongate member with at least two outer contact faces which are rolled around into a substantially circular shape and brought together with each other. Preferably, the contact faces are pressed against each other to form an intimate contact with each other. However, in a steel hot rolling mill the billet of steel used in production is normally at a temperature of between 900° C. and 1200° C., and at this temperature, the steel becomes covered in oxide scale very quickly.

Oxide scale prevents a good weld being formed between two steel surfaces that are pressed together. In the case of pipe or tube manufacture, the two outer edges of the pipe which are rolled around to form a circular pipe are heated up very rapidly to just below the melting point of steel at a temperature of typically greater than 1400° C. and the contact faces are forced together to cause extreme deformation of the contact faces. Any oxide scale that does form on the contact faces is therefore removed from the joint by the disrupted material, which is subsequently scraped off the joint.

The ERW pipe or tube manufacturing process is a solid state process and is similar to forge welding, where the oxide scale layer is broken through and disrupted by deformation of the contact face.

However, with the present invention, it is not always possible to cause sufficient disruption of the contact faces of a hot roll formed hollow bar in a steel mill to break through the oxide scale layer completely and form a good forge welded joint. Nevertheless, with a thick-walled hollow bar, which will be typically used as a self drilling rock bolt, groutable bolt or drill rod, it is not necessary to have a high strength joint because the wall section of the hollow bar is thick. Specifically, the wall section of the bar is designed such that the remaining wall section, other than the contact faces, is strong enough for the application that the bar will be used for.

This is a different way of designing a thick-walled hollow bar than all existing hollow bars, since it has an in-built, substantially weaker section in its wall. The present inventor has surprisingly further found that the tensile strength of the bar is not reduced by the hot roll forming process and the torsional strength of the bar has been found to be sufficient for the applications of self drilling rock bolts, groutable bolts and drill rods. A further benefit of the process of the present invention is that thick-walled hollow bars can be formed at extremely high speeds, and consequently at lower cost than by any other process.

### SUMMARY OF THE INVENTION

According to the present invention, there is provided a process to form a substantially thick-walled hollow bar by hot rolling an elongate member to form an internal hole, whereby the elongate member is formed around an internal hole and the outer edges of the elongate member are brought substantially into contact with each other, OR, in close proximity to each other such that the outer edges form substantially longitudinal contact faces capable of being forced into very close or intimate contact with each other.

Thus, in one aspect of the present invention, there is provided a process to form a substantially thick-walled hollow bar by hot rolling an elongate member to form an internal hole, whereby the elongate member is formed around an internal hole and the outer edges of the elongate member are brought substantially into contact with each other.

In a second aspect of the present invention, there is provided a process to form a substantially thick-walled hollow bar by hot rolling an elongate member to form and internal hole, whereby the elongate member is formed around an internal hole and the outer edges of the elongate member are brought into close proximity to each other such that the outer edges form substantially longitudinal contact faces capable of being forced into very close or intimate contact with each other. If the contact faces are forced together and are in intimate contact with each other, they may or may not form a forged welded joint.

The invention is also directed to a substantially thick-walled hollow bar whenever made by the process of the present invention.

The invention is also directed to the use of the process of the present invention to form a hollow bar and to the use of the hollow bar as a rock bolt, whether threaded or not, or as a drill rod.

Preferred Embodiments of the Invention The elongate member can be any suitable external shape, either with or without external ribs, and have an internal hole of any suitable shape, with at least one contact joint transecting the wall of the elongate member. Preferably, the elongate member is made from steel that can be rolled, deformed or folded into the shape of a hollow bar. The steel can be selected from the group steel, and stainless steel or other steel alloy. More preferably, the metal is high strength steel and may contain small quantities of nickel, chromium, vanadium or molybdenum.

The hollow bar is preferably formed in a steel hot rolling mill, where a hot billet of steel is rolled into an elongate member having at least two longitudinal edges on the outside of the elongate member. Typically, the hollow bar forming process is carried out at a speed, which is not less than that of the production speed of the hot rolling process in a steel mill.

Preferably, each outer edge of the elongate member has an adjacent contact face. The hollow bar forming process preferably further includes the step of pressing the outer edges of the elongate member together such that they form intimate contact faces with each other.

Preferably, the contact faces comprise longitudinal edges on the elongate member.

Preferably, there are two longitudinal edges that form at least two contact faces, but the invention may have any number of longitudinal edges and contact faces.

More preferably, the contact faces are brought into intimate contact with each other such that the hollow bar is adapted to receive fluids pumped into and/or through it.

Preferably further, the contact faces are bonded together by any suitable process such as by roll forge welding, hot forging, conventional welding, laser welding or blazing, but is in no way limited to these methods.

In a preferred embodiment of the invention, the hollow bar manufacturing process further includes the step of hot rolling ribs, deformations, or threads onto the outside of the hollow bar.

The elongate member of the present invention is preferably hot rolled into a shape with at least two substantially concave surfaces. The at least two concave surfaces are connected to each other by solid material of the elongate member, which forms a hinge point or rotational point for the at least two concave surfaces.

More preferably, in the hot rolling process the at least two concave surfaces are rotated with respect to each other about the hinge point or rotational point in the elongate member such that the concave surfaces are substantially facing each other to form an internal hole in the elongate member.

Preferably further, at least two outer edges of the concave surfaces form the longitudinal edges, which come together to form the contact faces with each other.

The contact edges are preferably squeezed together during the hot rolling process such that the contact faces are brought into intimate contact with each other.

Typically, the hole formed in the hollow bar is of any suitable shape and the hollow bar itself may be of any suitable shape.

The hollow bar is more preferably a thick-walled hollow bar, where the outer diameter of the hollow bar is less than eight times the average wall thickness of the bar.

Preferably further, the hollow bar is formed at a temperature in the range between 600° C. and 1200° C. It should be noted that the hollow bar is formed at a temperature, which is much less than the melting point of the bar. If the bar is made from steel, the melting point of the steel is typically between 1450° C. and 1600° C. steel, and most conventional steel welding techniques including ERW raise the temperature of the steel to close to or above its melting point.

Even more preferably, the hollow bar is a threaded rock bolt or a drill rod, which could have any suitable external shape including round, oval, square, rectangular or hexagonal but is not limited to these alone.

The contact faces of the hollow bar are typically specifically designed to generate high contact stresses when they are forced together in the rolling mill. Preferably further, the hollow bar is designed to provide space to accommodate deformed or disrupted material from the contact surfaces after they have been forced together.

Throughout this specification, the word “bar” refers to any elongate member and includes bars, rods, sections, flats, rounds, angles, half-bars, but is not limited to these in any way.

Where the specification refers to an “elongate member” it is to be understood that the invention includes all such variations and modifications of an elongate member and includes billets, bars, rods, flats, sections, tubes, pipes or wires, but is not limited to these.

Where the specification refers to a “hollow bar” it is to be understood that the invention includes all such variations and modifications of a hollow bar including a circular and non-circular hollow bars, but is not limited to these alone.

Where the specification refers to “contact surfaces” or to “contact faces” or to “contact edges”, it is to be understood that the invention includes all such variations and modifications of one or more contact surfaces along an elongate member whereby at least two contact surfaces can be brought into contact or close proximity to each other, but is not limited to these alone.

Where the specification refers to a “contact joint” it is to be understood that the invention includes all such variations and modifications of one or more contact joints which transect the wall thickness of the elongate member in a substantially axial direction and are formed by at least two contact surfaces which are abutting and in contact with each other or in close proximity to each other to form a closed or open “contact joint”, but is not limited to these alone.

Where the specification refers to a “hinge” or to a “hinge point” or to a “rotational point”, it is to be understood that the invention includes all such variations and modifications of a “hinge”, but it is normally considered to be the approximate point of an elongate member, where the outer sections of the cross section can be deformed or rotated about it such that the outer sections of the cross section can be brought into contact or close proximity with each other to form a substantially central hole in the elongate member.

### DETAILED DESCRIPTION OF THE INVENTION

The invention is further described by means of the following non-limiting examples: 1) Hot Rolling of Steel Bars, Rods and Sections Most steel and metal bars are produced in some type of rolling mill. In particular, steel bars, rods, flats and other longitudinal steel sections are commonly produced in a hot rolling mill.

The hot rolling process involves taking a billet of steel (typically 12 m long by 127 mm) and heating it up in a furnace to a temperature of between 900° C. and 1200° C. It is clearly much easier to “deform” or “shape” steel when it is hot rather than when it is cold.

When the billet has reached the required temperature, the billet is then taken out of the furnace and passed through a series of rolling stands. These rolling stands are pairs of large rollers, which sequentially reduce the size of the billet down to the shape and size of the final product. A rolling mill may typically have 10 to 20 rolling stands.

The reduction in size of the billet from one rolling stand to another rolling stand is restricted to within certain limits. However, each time the billet passes through a rolling stand, the cross-sectional area of the billet reduces, but the length increase to maintain constant volume.

Consequently, the speed of the billet increases each time it passes through a rolling stand.

When a billet enters the first rolling stand, it is typically moving at a speed of less than 0.5 metres per second. However, when the billet leaves the last rolling stand it is typically moving at 6 to 13 metres per second.

During the time the billet leaves the heating furnace until it passes through the last rolling stand, it loses some heat and the temperature drops slightly. The temperature may typically drop from say 1100° C. to 1200° C. in the furnace, to approximately 900° C. to I OOOOC at the last rolling stand, although the hot rolling process itself tends to input energy into the bar and maintain the temperature of the billet. When the billet leaves the last rolling stand, it is normally formed into the shape and size of the product, such as a bar or rod. The only additional manufacturing processes performed after the final rolling stand are normally controlled cooling processes such as passing the bar through a water spray or water bath to rapidly cool the bar to increase surface strength and hardness. These cooling processes would typically rapidly cool the surface of the bar to 600° C. to 700° C.

It is therefore evident that complex shapes can be formed by the hot rolling process.

The process described in the present invention uses the ability to form complex shapes in a hot rolling mill to form a thick-walled hollow bar.

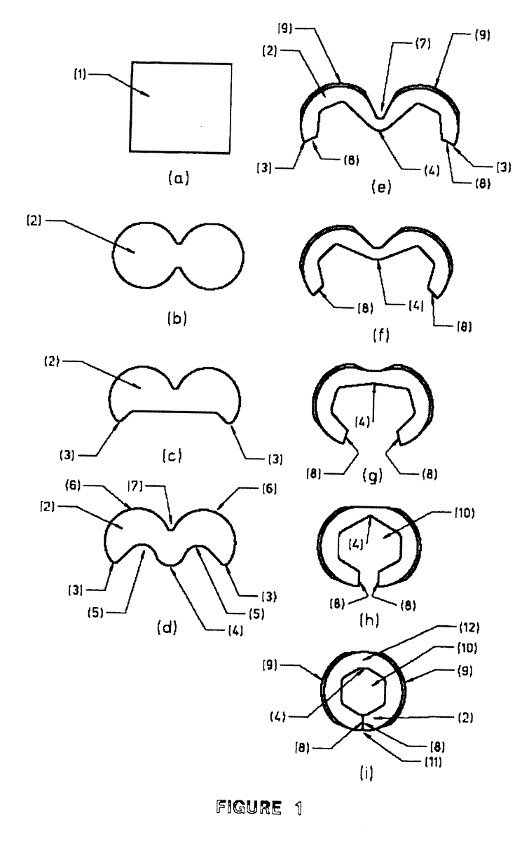

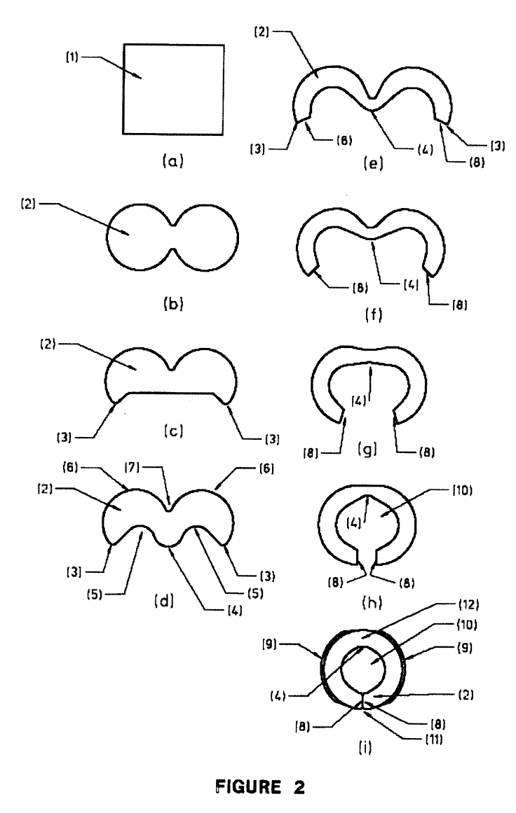

2) Hot Roll Forming a Hollow Bar A hollow bar can be formed in a hot rolling mill as shown in FIG. 1 and FIG. 2.

Preferably, a billet of steel is formed into an approximate “M” or “W” shape with two concave shapes connected by a central “hinge” point. In the steel rolling mill guide boxes, guide rollers and roll stands are used to deform the single bar about its hinge point (see FIG. 1 and FIG. 2), such that the two outer edges of the bar (the outer edges of the “M” or “W”) are substantially brought into contact or close to in contact, with each other (as shown in FIG. 1 (i) and FIG. 2 (i)). The above process of forming a hollow bar in a hot rolling mill can be used to form many different shaped hollow bars some examples of which are shown in FIGS. 1, 2, 3 & 4.

Throughout this specification, unless the context requires otherwise, the word “comprise”, or variations such as “comprises” or “comprising” will be understood to imply the inclusion of a stated integer or group of integers, but not to the exclusion of any other integer or group of integers.

### DETAILED DESCRIPTION OF THE DRAWINGS

FIGS. 1, 2, 3 & 4 all show detailed cross sections through elongate members and hollow bars which are formed according to the present invention.

FIG. 1 shows the progressive formation of a hollow bar or elongate member with external ribs where the external ribs are formed when they are fully supported by the rolls in the rolling mill.

FIG. 1 (a) shows a section through a billet of steel (1) that is heated up in a furnace to between 900° C. and 1200° C. in a steel mill just prior to hot rolling.

FIG. 1 (b) shows a section through an elongate member (2) which has been rolled into an approximate “peanut” or “dog bone” type shape in the hot rolling mill from the original billet of steel (1).

FIG. 1 (c) shows section through the elongate member (2), which has been further deformed and shaped in the hot rolling mill and which has at least two outer longitudinal edges (3).

FIG. 1 (d) shows a section through the elongate member (2) which has been yet further deformed and shaped in the hot rolling mill to form a thick “M” or “W” shape with at least two outer approximately convex surfaces (6) separated by at least one approximately concave surface (7) and with at least two approximately concave surfaces (5) separated by a hinge or rotation point (4) of the elongate member (2).

FIG. 1 (e) shows a section through the elongate member (2) which has been still further deformed and shaped in the hot rolling mill to form a thinner “M” or “W” shape with external ribs (9) formed on the convex sections (6) of the “M” or “W” shape and with at least two contact faces (8) having been formed.

FIG. 1 (f) shows a section through the elongate member (2) which has been even further deformed and shaped in the hot rolling mill to begin to rotate the outer contact faces (8) of the elongate member (2) about at least one hinge point (4).

FIG. 1 (g) shows a section through the elongate member (2) which has been progressively deformed and shaped in the hot rolling mill to further rotate the outer contact faces (8) of the elongate member (2) about a hinge point (4).

FIG. 1 (h) shows a section through the elongate member (2) which has continued to be progressively deformed and shaped in the hot rolling mill to even further rotate the outer contact faces (8) of the elongate member (2) about a hinge point (4) such that they are in close proximity to each other.

FIG. 1 (i) shows a section through the elongate member (2) which has been progressively deformed and shaped in the hot rolling mill to bring the outer contact faces (8) of the elongate member (2) into contact with each other to form a contact joint (11) and with ribs (9) on the outside of the elongate member (2) and where the wall thickness (12) of the elongate member (2) at or adjacent to the hinge point (4) may increase in thickness or be deformed.

FIG. 2 shows the progressive formation of a hollow bar or elongate member with external ribs where the external ribs are formed at the last rolling stand in the rolling mill.

FIG. 2 (a) shows a section through a billet of steel (1) that is heated up in a furnace to between 900° C. and 1200° C. in a steel mill just prior to hot rolling.

FIG. 2 (b) shows a section through an elongate member (2) which has been rolled into an approximate “peanut” or “dog bone” type shape in the hot rolling mill from the original billet of steel (1).

FIG. 2 (c) shows section through the elongate member (2) which has been further deformed and shaped in the hot rolling mill and which has at least two outer longitudinal edges (3).

FIG. 2 (d) shows a section through the elongate member (2) which has been yet further deformed and shaped in the hot rolling mill to form a thick “M” or “W” shape with at least two outer approximately convex surfaces (6) separated by at least one approximately concave surface (7) and with at least two approximately concave surfaces (5) separated by a hinge or rotation point (4) of the elongate member (2).

FIG. 2 (e) shows a section through the elongate member (2) which has been still further deformed and shaped in the hot rolling mill to form a thinner “M” or “W” shape with at least two contact faces (8) having been formed.

FIG. 2 (f) shows a section through the elongate member (2) which has been even further deformed and shaped in the hot rolling mill to begin to rotate the outer contact faces (8) of the elongate member (2) about at least one hinge point (4).

FIG. 2 (g) shows a section through the elongate member (2) which has been progressively deformed and shaped in the hot rolling mill to further rotate the outer contact faces (8) of the elongate member (2) about a hinge point (4).

FIG. 2 (h) shows a section through the elongate member (2) which has continued to be progressively deformed and shaped in the hot rolling mill to even further rotate the outer contact faces (8) of the elongate member (2) about a hinge point (4) such that they are in close proximity to each other.

FIG. 2 (i) shows a section through the elongate member (2) which has been progressively deformed and shaped in the hot rolling mill to bring the outer contact faces (8) of the elongate member (2) into contact with each other to form a contact joint (11) and with ribs (9) formed on the outside of the elongate member (2) and where the wall thickness (12) of the elongate member (2) at or adjacent to the hinge point (4) may increase in thickness or be deformed.

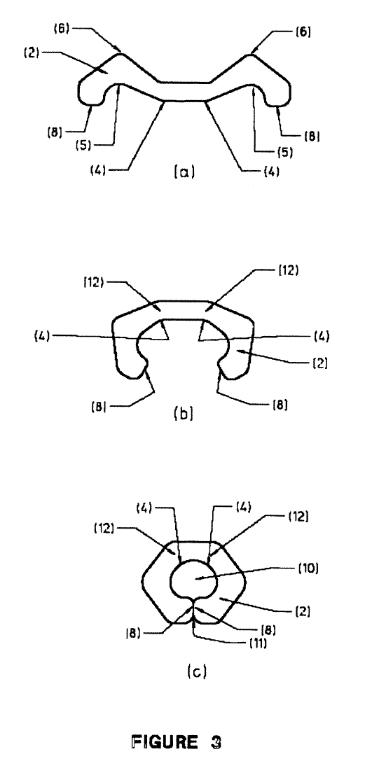

FIG. 3 shows the progressive formation of a hollow bar or elongate member with an approximate hexagonal external shape where the hexagonal hollow bar is formed by deforming the elongate member about a plurality of hinge points in the rolling mill.

FIG. 3 (a) shows a section through the elongate member (2) which has been deformed and shaped in the hot rolling mill to form a thick and flattened “M” or “W” shape with at least two outer approximately convex surfaces (6) separated by at least one approximately concave surface (7) and with at least two approximately concave surfaces (5) separated by at least one hinge or rotation point (4) of the elongate member (2) and with at least two contact faces (8) having been formed.

FIG. 3 (b) shows a section through the elongate member (2) which has been further deformed and shaped in the hot rolling mill to begin to rotate the outer contact faces (8) of the elongate member (2) about in this case two hinge points (4) and where the wall thickness (12) at or adjacent to the hinge point (4) may increase or be deformed.

FIG. 3 (c) shows a section through the hexagonal elongate member (2) which has been progressively deformed and shaped in the hot rolling mill substantially by rotating the outer contact faces (8) of the elongate member (2) about the hinge points (4) such that the contact faces (8) are in contact with each other to form a contact joint (11) and where the wall thickness (12) of the elongate member (2) at or adjacent to the hinge points (4) may increase in thickness or be deformed.

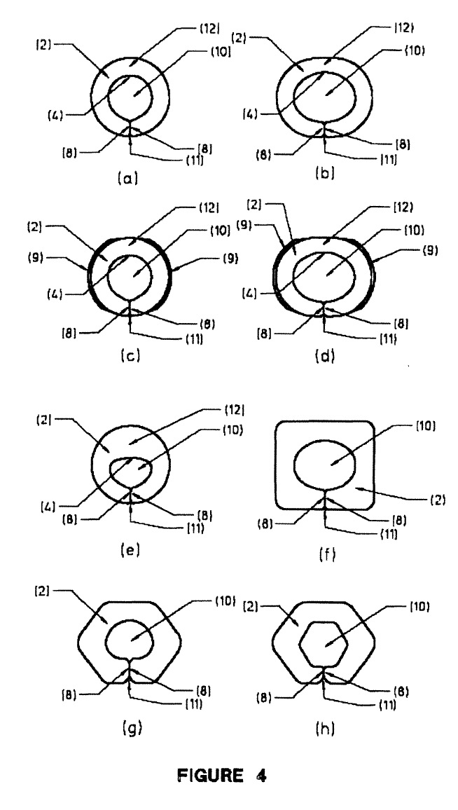

FIG. 4 shows sectional views of different embodiments of the present invention.

FIG. 4 (a) shows a section through an elongate member (2) which is substantially circular in external shape and has a substantially circular central hole (10) which is enclosed by a thick wall thickness (12) which has been deformed about at least one hinge point (4) to enable at least two contact faces (8) to come in contact with each other or in close proximity to each other at a contact joint (11).

FIG. 4 (b) shows a section through an elongate member (2) which is substantially non-circular in external shape and has a substantially non-circular central hole (10) which is enclosed by a thick wall thickness (12) which has been deformed about at least one hinge point (4) to enable at least two contact faces (8) to come in contact with each other or in close proximity to each other at a contact joint (11).

FIG. 4 (c) shows a section through an elongate member (2) which is substantially circular in external shape and has external ribs (9) and has a substantially circular central hole (10) which is enclosed by a thick wall thickness (12) which has been deformed about at least one hinge point (4) to enable at least two contact faces (8) to come in contact with each other or in close proximity to each other at a contact joint (11).

FIG. 4 (d) shows a section through an elongate member (2) which is substantially non-circular in external shape and has external ribs (9) and has a substantially non-circular central hole (10) which is enclosed by a thick wall thickness (12) which has been deformed about at least one hinge point (4) to enable at least two contact faces (8) to come in contact with each other or in close proximity to each other at a contact joint (11).

FIG. 4 (e) shows a section through an elongate member (2) which is substantially circular in external shape and has a central hole (10) which is both non-circular and non-central to the elongate member (2) such that the wall thickness (12) is not uniform around the section of the elongate member (2) and where the elongate member (2) has been deformed about at least one hinge point (4) to enable at least two contact faces (8) to come in contact with each other or in close proximity to each other at a contact joint (11).

FIG. 4 (f) shows a section through an elongate member (2) which is substantially square in external shape and has a central hole (10) and a contact joint (11) formed by two contact faces (8) in contact with or in close proximity to each other.

FIG. 4 (g) shows a section through an elongate member (2) which is substantially hexagonal in external shape and has a central hole (10) and a contact joint (11) formed by two contact faces (8) in contact with or in close proximity to each other.

FIG. 4 (h) shows a section through an elongate member (2) which is substantially hexagonal in external shape and has a hexagonal central hole (10) and a contact joint (11) formed by two contact faces (8) in contact with or in close proximity to each other.

The elongate member (2) can be any suitable external shape, either with or without external ribs (9), and have an internal hole (10) of any suitable shape, with at least one contact joint (11) transecting the wall of the elongate member (2).

Those skilled in the art will also appreciate that the invention described herein is susceptible to variations and modifications other than those specifically described. It is to be understood that the invention includes all such variations and modifications. The invention also includes all of the steps, features, compositions, and compounds referred to or indicated in this specification, unless specifically excluded, individually or collectively, and any and all combinations of any two or more of said steps or features.

We claim:

1. A method of forming a substantially thick-walled hollow bar by hot rolling an elongate member to form an internal hole, comprising:
forming the elongate member around the internal hole and bringing the outer edges of the elongate member substantially into contact with each other.

2. A method according to claim 1, wherein each outer edge of the elongate member has an adjacent contact face.

3. A method according to claim 2, wherein the at least one longitudinal edge on the elongate member has at least one contact face.

4. A method according to claim 2, wherein there are two longitudinal edges that have at least one contact face.

5. A method according to claim 1, further comprising pressing the outer edges of the elongate member together such that its contact face(s) form an intimate contact joint.

6. A method according to claim 1, wherein the internal hole has at least one contact joint transecting the wall of the elongate member.

7. A method of forming a substantially thick-walled hollow bar by hot rolling an elongate member to form an internal hole comprising:
forming the elongate member around an internal hole and bringing the outer edges of the elongate member into close proximity to each other such that the outer edges form substantially longitudinal contact faces capable of being forced into very close or intimate contact with each other.

8. A method according to claim 7, further comprising bringing the contact faces into intimate contact with each other along the length of the elongate member, such that the hollow bar is adapted to receive fluids pumped into and/or through it.

9. A method according to claim 2, further comprising bonding the contact faces together by any suitable bonding process selected from roll forge welding, hot forging, conventional welding, laser welding or brazing.

10. A method according to claim 9, further comprising hot rolling at least one of a rib, a deformation or a thread onto the outer surface of the hollow bar.

11. A method according to claim 7, further comprising hot rolling the elongate member into a shape with at least two substantially concave surfaces, wherein the concave surfaces are connected to each other by the solid material of the elongate member, which forms at least one hinge or rotational point for the concave surfaces.

12. A method according to claim 11, further comprising rotating the concave surfaces with respect to each other about the hinge or rotational point in the elongate member, such that the concave surfaces are substantially facing each other to form an internal hole in the elongate member.

13. A method according to claim 11, wherein the outer edges of the concave surfaces form the longitudinal edges, which come together to form the contact faces with each other.

14. A method according to claim 7, further comprising squeezing the contact edges together during the hot rolling process such that the contact faces are brought into intimate contact with each other.

15. A method according to claim 7, wherein the process takes place in a steel hot rolling mill wherein the process is carried out at a speed, which is not less than that of the production speed of the hot rolling process in a steel mill.

16. A method according to claim 7, wherein the hole formed in the hollow bar is of any suitable shape.

17. A method according to claim 7, wherein the outer diameter of the hollow bar is less than eight times the average wall thickness of the bar.

18. A method according to claim 7, further comprising forming the hollow bar at a temperature in the range between 600° C. and 1200° C.

19. A method according to claim 7, wherein the hollow bar is one of a threaded rock bolt or a drill rod.

20. A method according to claim 19, wherein the rock bolt or drill rod is of any suitable shape selected from round, oval, square, rectangular or hexagonal.

21. A method according to claim 7, wherein the elongate member is made from steel selected from stainless steel or other steel alloy that can be rolled, deformed or folded into the shape of a hollow bar.

22. A method according to claim 21, wherein the steel is a high strength steel containing small quantities of nickel, chromium, vanadium or molybdenum.
